(19) United States
(12) Patent Application Publication
(10) Pub. No.: US 2008/0144902 A1
(43) Pub. Date: Jun. 19, 2008

(54) Optimal block searching algorithm for tissue displacement estimation in elasticity imaging

(75) Inventor: Emil G. Radulescu, New Haven, CT (US)

Correspondence Address: BACHMAN & LAPOINTE, P.C., 900 CHAPEL STREET, SUITE 1201, NEW HAVEN, CT, 06510, US

(73) Assignee: Aloka Co., Ltd.

(21) Appl. No.: 11/586,406

(22) Filed: Oct. 25, 2006

(51) Int. Cl. G06K 9/00

(52) U.S. Cl. 382/130

(57) ABSTRACT

Disclosed is a method and system that efficiently compares data from two ultrasound images and derives a tissue displacement map for real-time diagnostic imaging applications.

### BACKGROUND OF THE INVENTION

The invention relates generally to the field of elasticity imaging. More specifically, embodiments of the invention relate to methods and systems that efficiently compare data from two ultrasound radio frequency (RF) data frames and derive a tissue displacement map.

Pathological conditions often produce changes in biological tissue stiffness. For example, the tissues of tumors exhibit different mechanical properties than their surrounding tissue as demonstrated by using palpation as a diagnostic tool. Breast and prostate tumors are especially susceptible to changes in mechanical properties.

Many cancers, such as scirrhous carcinoma of the breast, appear as extremely hard nodules. However, a lesion may or may not possess echogenic properties that would make it detectable using conventional ultrasound imaging systems. Prostate or breast tumors may be difficult to distinguish using conventional ultrasound techniques, yet may still be much stiffer than the surrounding tissue.

Recently, experimental elastic modulus data taken for normal and abnormal breast tissues obtained at different ultrasound frequencies and precompression strain levels showed that the differences between the elastic moduli of the different tissues of the breast may be useful in developing methods to distinguish between benign and malignant tumors. Tissues of the prostate were also examined as cancers of the prostate are also significantly stiffer than normal tissue. Similar data indicating differences between the elastic moduli for normal and abnormal prostate tissues were also reported.

The imaging modality that facilitates the display of mechanical properties of biological tissue is called elastography. Elastography is an emerging method in which stiffness or strain images of soft tissue are used to detect tumors. When a mechanical compression is applied, the tumor deforms less than the surrounding tissue, i.e., the strain in the tumor is less than the surrounding tissue.

The purpose of elastography is to display an image of the distribution of a physical parameter related to the mechanical properties of the tissue for clinical applications. Elasticity imaging consists of inducing an external or internal motion to the suspect tissue and evaluating the response of the tissue using conventional diagnostic ultrasound imaging and correlation techniques.

Each elasticity imaging application comprises three functional components. First, the data is captured during an externally or internally applied tissue motion or deformation. Second, the tissue response is evaluated by determining displacement, stress and strain. Lastly, the elastic modulus of the tissue is reconstructed using the theory of elasticity. The last step involves implementing the theory of elasticity into modeling and solving the inverse problem from strain and boundary conditions to a modulus of elasticity. Since modeling elasticity depends on the structure of the biological tissue and boundary conditions, implementation of the last function is cumbersome and typically not performed for commercial applications. The evaluation and display of tissue strain in the second function is considered to deliver an accurate reproduction of the tissue's mechanical properties.

The most frequently used modality is static elasticity imaging. In this application, a small quasi-static compressive force is applied to the tissue using the ultrasound imaging transducer. The force can be applied either using motorized compression fixtures or using freehand scanning. The radio frequency (RF) data acquired prior to and during compression is recorded and compared to estimate the local axial and lateral motions using correlation methods. The estimated motions along the ultrasound propagation direction represent the axial displacement map of the tissue and are used to determine an axial strain map. The strain map is then displayed as a gray scale or color-coded image and is called an elastogram.

While the majority of elasticity image processing has been performed off-line, real-time elasticity imaging applications for use in clinical environments is a primary concern. Real-time elasticity imaging is needed to process the ultrasonic image data such that patient scanning time is minimal and diagnostically relevant elasticity images are immediately produced. Real-time elasticity imaging systems are capable of displaying ultrasonic B-mode images and strain images on the same user display. The combined display aids in assessing the clinical relevance of the derived strain images.

Real-time processing of ultrasonic image data allows for freehand compression and scanning of a suspect area rather than needing a slow and bulky motorized compression fixture. Freehand compression, as opposed to motorized compression, allows for a manageable and user-friendly scanning process for use in a larger variety of scanning locations. Its disadvantage, however, consist of exhaustive operator training, as the sonographer constantly needs to adjust the compression technique to obtain strain images of good quality. To obtain consistent strain images exhibiting superior elasticity dynamic range DRₑ, and signal-to-noise ratio SNRₑ, the sonographer needs to maintain a constant compression rate while avoiding lateral and out-of-plane tissue motions. Moreover, the compression has to be performed exclusively on the axial direction of the imaging transducer while maintaining a certain speed and repetition period.

Given the advantages of real-time ultrasonic echo data processing, there is a need for an efficient method to produce accurate and reliable elasticity images. The most time-intensive aspect of processing RF data is the estimation of motions along the ultrasound propagation direction. There is therefore a need to optimize this process.

### SUMMARY OF THE INVENTION

Although there are various methods and systems that process ultrasound RF and data into a tissue displacement map, such methods and systems are not completely satisfactory. The inventors have discovered that it would be desirable to have methods and systems that efficiently process ultrasound image data into a tissue displacement map for real-time diagnostic imaging applications.

One aspect of the invention provides methods for determining a best displacement between first and second data frames containing RF data values. Methods according to this aspect of the invention preferably start with indexing the RF data values for the first and second frames, choosing an RF data value from the first frame as a center point, creating a reference block comprising a plurality of first frame RF data values surrounding the center point, choosing a displacement from a finite number of displacements between the center point and an RF data value that maps to an RF data value in the second frame, performing a sum of even power differences (SEPD) between the reference block RF data values and RF data values in the second frame displaced by the displacement that map to the reference block RF data values and form a candidate block comprising a) setting a minimum SEPD, b) calculating a current SEPD from a difference between a reference block RF data value and a corresponding candidate block RF data value with the difference raised to an even power, and c) comparing the current SEPD with the minimum SEPD.

Another aspect of the method is repeating steps b) and c) for another reference block RF data value if the current SEPD is less than or equal to the minimum SEPD, and summing each subsequent current SEPD with a previous current SEPD.

Another aspect of the invention provides methods for determining a best displacement between first and second data frames containing RF data values. Methods according to this aspect of the invention preferably start with indexing the RF data value positions for the first and second frames, choosing an RF data value from the first frame as a center point, creating a reference block comprising a plurality of first frame RF data values surrounding the center point, choosing a displacement from a finite number of displacements between the center point and an RF data value that maps to an RF data value in the second frame, comparing each reference block RF data value with each other to find the largest value, and performing a sum of even power differences (SEPD) between the reference block RF data values and RF data values in the second frame displaced by the displacement that map to the reference block RF data values and form a candidate block comprising a) calculating a current SEPD from a difference between a reference block RF data value and a corresponding candidate block RF data value with the difference raised to an even power.

Another aspect of the method is choosing a subsequent displacement, comparing each reference block RF data value with each other to find a next largest value, and performing a sum of even power differences (SEPD) between the reference block RF data values and RF data values in the second frame displaced by a subsequent displacement that map to the reference block RF data values and form a candidate block comprising: a) calculating a current SEPD from a difference between the largest reference block RF data value and a corresponding candidate block RF data value with the difference raised to an even power.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is an exemplary search pattern for a block matching algorithm.

FIG. 1B is an exemplary search pattern for a block matching algorithm within a defined search area.

FIG. 2 is a block diagram of an exemplary optimized sum of even powered differences method according to the invention.

FIG. 3 is an exemplary spiral search pattern for the optimized sum of even powered differences method shown in FIG. 2.

FIG. 4 is an exemplary spiral search pattern starting on a best predicted value within a defined search area not centered on the prediction value.

FIG. 5 is an exemplary optimized spiral search pattern beginning on a best predicted value within a defined search area.

FIG. 6 is a block diagram of an exemplary initialization procedure according to the invention.

FIG. 7 is a block diagram of an exemplary optimized sum of even powered differences method with partial sorting according to the invention.

FIG. 8 is an exemplary framework of the modules of the invention.

### DETAILED DESCRIPTION

Embodiments of the invention will be described with reference to the accompanying drawing figures wherein like numbers represent like elements throughout. Further, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

The invention is not limited to any particular software language described or implied in the figures. A variety of alternative software languages may be used for implementation of the invention. Some components and items are illustrated and described as if they were hardware elements, as is common practice within the art. However, various components in the method and system may be implemented in software or hardware.

Embodiments of the invention provide methods, systems, and a computer-usable medium storing computer-readable instructions that efficiently process ultrasound RF image data into a tissue displacement map for real-time diagnostic imaging applications. The invention efficiently compares data from two ultrasound radio frequency (RF) data frames and derives a tissue displacement map. The invention is a modular framework and may be deployed as hardware resident in an enclosure having an onboard power supply, or as software as an application program tangibly embodied on a program storage device for executing with a computer or processor. The application code for execution may reside on a plurality of different types of computer readable media.

By way of background, ultrasonography (sonography) uses a probe containing a plurality of acoustic transducers to send pulses of sound into a material. A sound wave is typically produced by creating short, strong pulses of sound from a phased array of piezoelectric transducers encased in a probe. The frequencies used for medical imaging are generally in the range of from 1 to 13 MHz which are medium to high radio frequencies (RF) and produce a single, focused arc-shaped sound wave from the sum of all the individual pulses emitted by the transducer. Higher frequencies have a correspondingly lower wavelength and yield higher resolution images.

Whenever the sound wave encounters a material with a different acoustical impedance, part of the sound wave is reflected, which the probe detects as an echo. The return sound wave vibrates the transducer's elements and turns that vibration into electrical pulses that are sent from the probe to a processor where they are processed and transformed into a digital image. The time it takes for the echo to travel back to the probe is measured and used to calculate the depth of the tissue interface causing the echo. The greater the difference between acoustic impedances, the larger the echo is. The difference between gases and solids is so great that most of the acoustic energy is reflected, and so imaging of objects beyond that region is not possible.

The speed of sound is different in different materials, and is dependent on the acoustic impedance of the material. However, an ultrasound scanner assumes that the acoustic velocity is constant at 1540 m/s. Although part of the acoustic energy is lost every time an echo is formed, this effect is small compared to the attenuation of sound due to absorption.

To generate a 2-dimensional image, the ultrasound beam is swept, either mechanically, or electronically using a phased array of acoustic transducers. The received RF data is further processed and used to construct the conventional ultrasound image.

The processor must determine from each received echo, which transducer elements received the echo since there are multiple elements on a transducer, the strength of each echo, and the time difference from when the sound was transmitted and when the echo was received. Once a determination is made, the processor can locate which value in a frame is present and to what magnitude.

The received data is referred to as RF data values and its representation is similar to that of a matrix. For example, with I indentifying rows (axial) and J identifying columns (lateral) where 1=1, 2, 3, . . . ,M and J=1, 2, 3, . . . ,N. The RF data values a_{I,J} are typically bipolar (±) multi-bit values. For example, a 2048×128 RF data frame may have 262,144 values a_{I,J}.

For elasticity imaging, the invention processes ultrasound RF data in real-time using intelligent search strategies in conjunction with block matching methods. The invention maximizes throughput by minimizing computation resources.

The invention provides displacement estimates of tissue motions between two RF data frames in axial (I) and lateral (j) directions. A first RF frame may be a non-compressed tissue section, the second RF frame is of the same ultrasound tissue section, but compressed in an axial (I) direction with regard to tissue surface.

Motion estimation takes an array of RF data values from a first RF data frame and attempts to find a close match in a second RF data frame. The result is the motion between the two RF data frames. A motion estimation operation finds a motion vector that indicates the best direction of the motion and a fitness score for that motion vector. The motion vectors are identified and collated as a displacement estimate map. An elasticity image (strain image) is subsequently computed from the gradient of the displacement map.

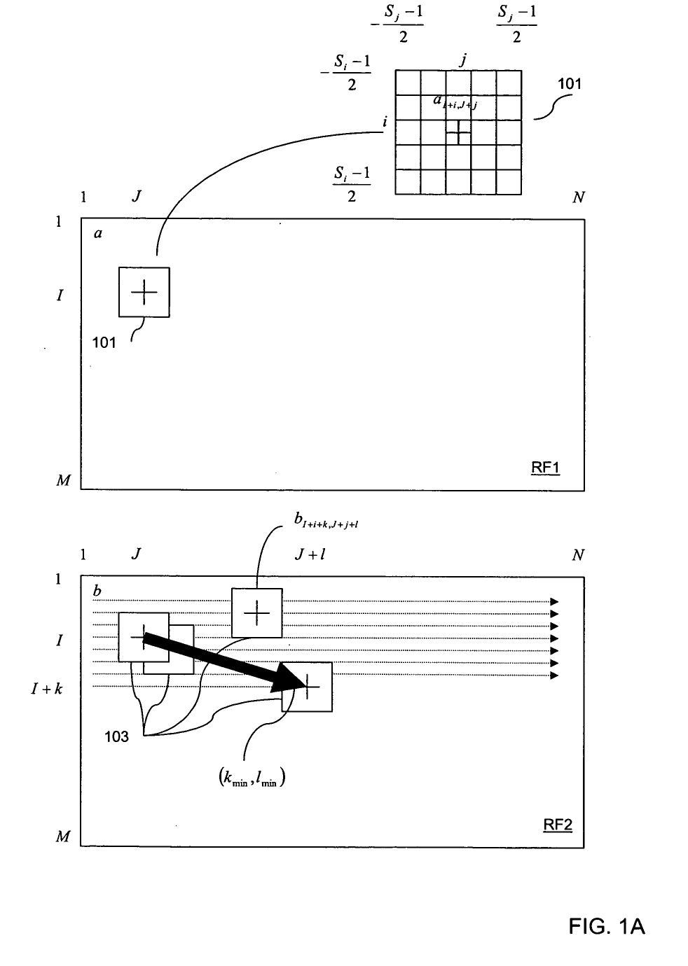

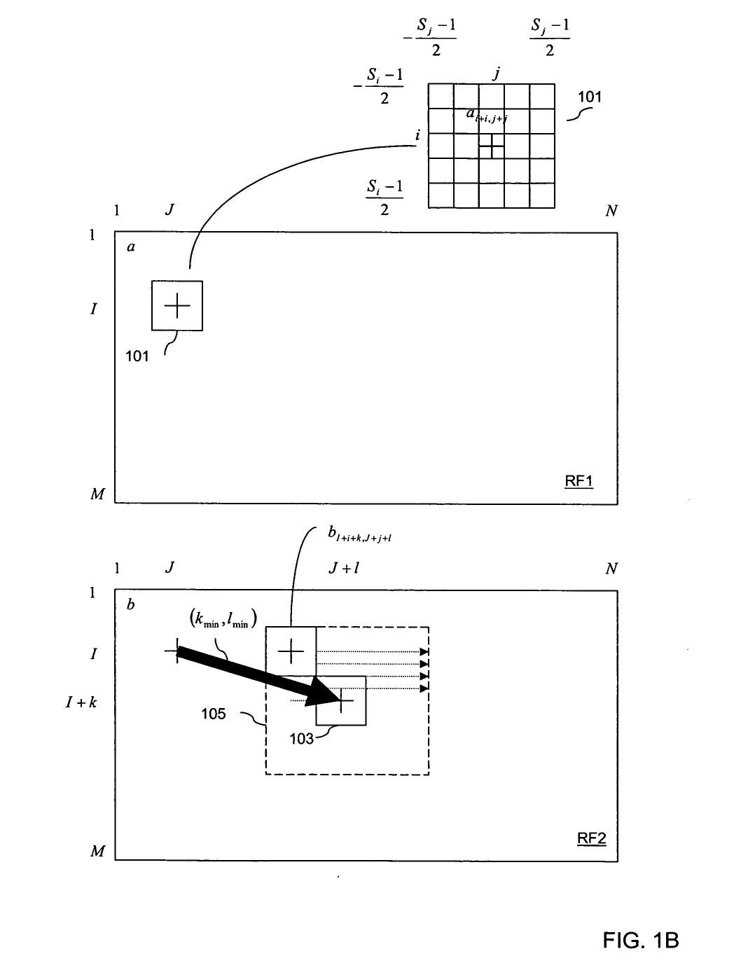

Shown in FIG. 1A is an example of a block matching method used in conjunction with the invention. The process of block matching is to find a candidate block 103 within a search area in another RF frame RF2 which is most similar to a reference block 101 in the present RF frame RF1. The similarity is gauged according to a fitness score.

Each RF frame RF1, RF2 may be comprised of bipolar (±) RF data a_{I,J}, b_{I,J} values. As already mentioned, as a general reference, vertical (axial) directions are denoted as I and horizontal (lateral) directions as J.

One data value, for example a_{10,10} (I=10; J=10) from the first RF frame RF1 may be chosen as a reference center location for the reference block 101. An array, or block of RF data values a_{I+i,J+j} from the first RF frame RF1 is selected as a kernel surrounding the center location. i and j are local vertical and horizontal indices, respectively. i takes values between

$$- \frac{{S}_{i} - 1}{2} and \frac{{S}_{i} - 1}{2} ,$$

and where Sᵢ is the vertical, or axial, kernel size and may be an odd number. Similarly, j takes values between

$$- \frac{{S}_{j} - 1}{2} and \frac{{S}_{j} - 1}{2} ,$$

and where Sⱼ is the horizontal, or lateral kernel size and may be an odd number. FIG. 1A shows a reference block 101 comprised of 25 data points a_{I+i,J+j} centered at I,J (a_{I,J}). The reference block 101 may be square in shape as shown, or may be any shape. Either Sᵢ or Sⱼ may be even numbers as well. In these cases, for an even Sᵢ, i takes values either between

$$- \frac{{S}_{i}}{2} + 1 and \frac{{S}_{i}}{2} ,$$

or between and Similarly, for an even Sⱼ, j takes values either between

$$- \frac{{S}_{j}}{2} + 1 and \frac{{S}_{j}}{2} ,$$

or between

$$- \frac{{S}_{j}}{2} and \frac{{S}_{j}}{2} - 1.$$

Any combination of even and odd Sᵢ and Sⱼ is possible.

The reference block 101 is compared with a plurality of candidate blocks 103 of the same size b_{I+i+k,J+j+1} in the second RF frame RF2, or in a predefined search area 105 within the second frame RF2 as shown in FIG. 1B. The comparison may begin at the location of the reference block 101 in the first RF frame RF1 I,J, b_{I,J}, or at a predefined +k,+l location b_{I+i+k,J+j+1}. Same as above, i takes values between

$$- \frac{{S}_{i} - 1}{2} and \frac{{S}_{i} - 1}{2} ,$$

where Sᵢ is the vertical, or axial, kernel size and may be an odd number. Similarly, j takes values between

$$- \frac{{S}_{j} - 1}{2} and \frac{{S}_{j} - 1}{2} ,$$

where Sⱼ is the horizontal, or lateral, kernel size and may be an odd number. As already mentioned, either Sᵢ or Sⱼ can be even numbers as well. In these cases, for an even Sᵢ, i takes values either between

$$- \frac{{S}_{i}}{2} + 1 and \frac{{S}_{i}}{2} ,$$

or between

$$- \frac{{S}_{i}}{2} and \frac{{S}_{i}}{2} - 1.$$

Similarly, for an even Sⱼ, j takes values either between

$$- \frac{{S}_{j}}{2} + 1 and \frac{{S}_{j}}{2} ,$$

or between

$$- \frac{{S}_{j}}{2} and \frac{{S}_{j}}{2} - 1.$$

Any combination of even and odd Sᵢ and Sⱼ is possible.

The difference between the location found in the second frame RF2 for the candidate block 103 exhibiting the best match I+k,J+l, and the location of the reference block 101 in the first frame RF1 I,J is the displacement k,l and forms a vector for that respective reference block 101 indicating motion in both axial (I) and lateral (J) directions. The best match is shown as a bold arrow. A displacement map is collated from a plurality of different reference block/best candidate block matches showing axial and lateral displacements between the first RF1 and second RF2 RF frames.

The reference block 101 is indexed, from left to right, top to bottom, across the entire second data frame RF2 as shown in FIG. 1A, or within the predetermined search area 105 as shown in FIG. 1B, as the reference block 101 is compared with candidate blocks 103 in the second RF frame RF2. The indexing of candidate block 103 locations to search may be performed from one data position b_{I+i+k,J+j+1} to the next b_{I+i+k,J+j+(l+1)} or b_{I+i+(k+1),J+j+1}. For each new reference block/candidate block comparison, a fitness score is calculated. A variety of methods exist to determine similarity, or fitness, between a reference block 101 and a candidate block 103.

One method used is the sum-of-squared differences (SSD) The SSD computes the sum of the differences between RF data values a_{i,j} from a reference kernel block 101 and data points b_{i,j} from a candidate kernel block 103, and yields a fitness score SSD(k,l). The equation for an SSD(k,l) score for a given displacement vector is

$$SSD ( k , l ) = {{\sum }_{kernel}}_{window} {[ RF 1 ( i , j ) - RF 2 ( i + k , j + l ) ]}^{2} , \qquad ( 1 )$$

where RF1 is the first data set, RF2 is the second data set, k is an axial displacement, l is a lateral displacement and

$${{\sum }_{kernel}}_{window}$$

is a sum or all values in a candidate block. In (1) kernel window stands for the entire block (i,j) surrounding the center location.

The comparison between a reference block 101 and all candidate blocks 103 is systematically carried out for the entire second RF frame RF2, or a predetermined search area 105. Within the search area, a best match is found that minimizes an error measure between the reference block 101 and all candidate blocks 103. The displacements for a plurality of reference blocks in both axial and lateral coordinates is tabulated forming a displacement map. If a search of all possible candidate block displacements in the entire second RF frame RF2 is compared, the result would be computationally expensive.

The optimized block matching method of the invention uses intelligent search strategies that reduce execution time and computation resources. Each aspect of the invention is described below in detail.

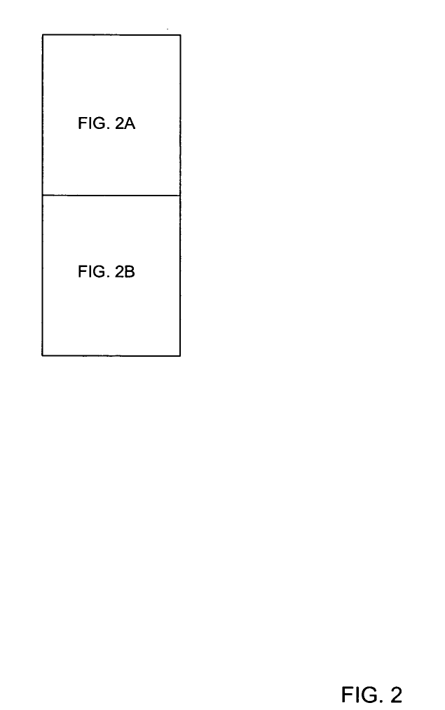

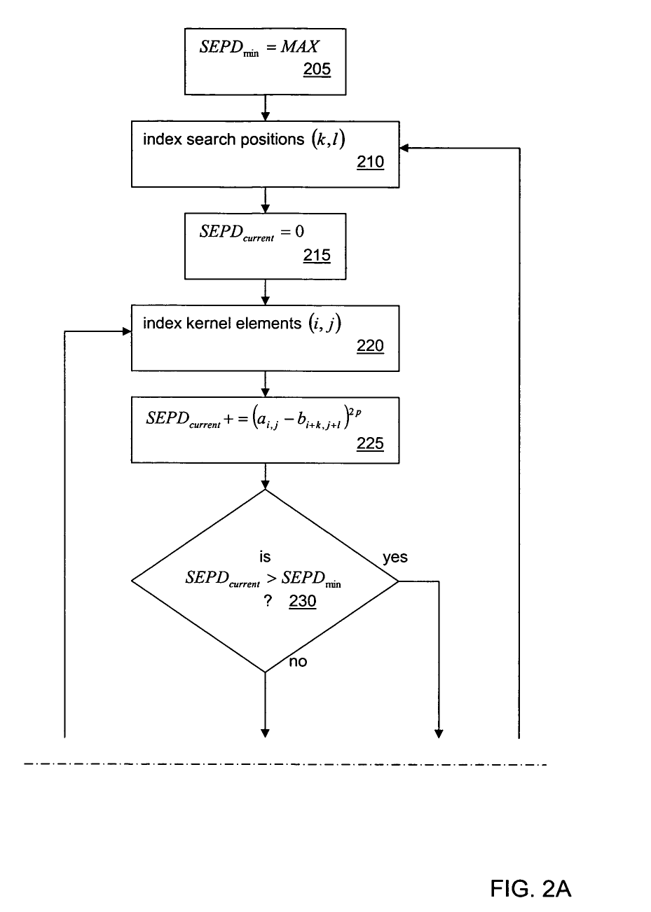

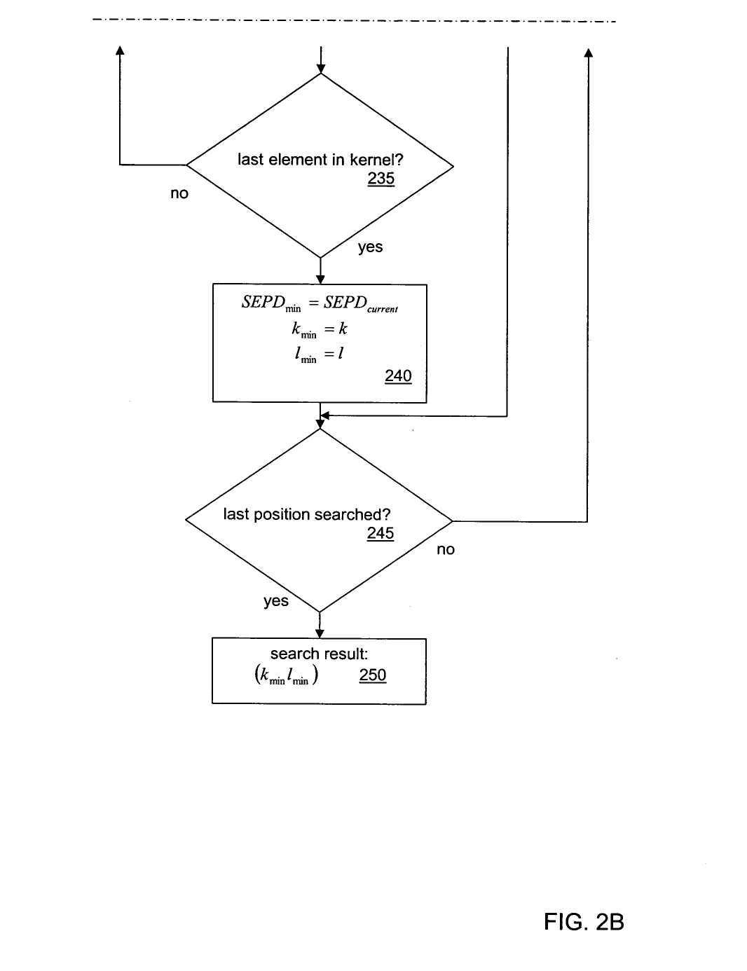

Shown in FIG. 2 is a first method of the invention. An intelligent block matching operation is performed by searching for a minimum score or fitness variable SEPDₘᵢₙ which is the minimum of all of the sum of even powered differences (SEPD). SEPDₘᵢₙ is an error measurement.

The method begins by initializing SEPDₘᵢₙ to a maximum value MAX (step 205). The value MAX is a predetermined value that is chosen to be large enough to exceed any SEPDₘᵢₙ values obtained while executing the method.

The search positions in the second RF frame RF2 are represented by (k,l) and are incremented one value k and l at a time. (k,l) indicates the center of a candidate block 103 location (step 210) and represents the displacement between the reference block 101 and candidate block 103. The variables k and l may take on values such as (0,0),(0,1),(0,2), . . . , (0,lₘₐₓ), . . . , (kₘₐₓ,0),(kₘₐₓ,1), (kₘₐₓ,2), . . . ,(kₘₐₓ,lₘₐₓ), where kₘₐₓ,lₘₐₓ represent the maximum search values of k and l, respectively.

For each search position (k,l), the value of the SEPD SEPD_{current} is initialized to 0 (step 215). The RF data values a_{i,j} comprising the reference block 101 over which the SEPD is computed are represented by (i,j). Note that for simplification, the global coordinates I,J are from now on omitted. The search method is explained for a given value of (I,J). (i,j) are incremented one value at a time to gradually encompass the entire reference block 101 area over which the SEPD is computed (step 220). SEPD_{current} is defined as

SEPD_{current}+=(a_{i,j}−b_{i+k,j+1})^{2p}, (2)

where a_{i,j} represents reference block 101 RF data values and b_{i+k,j+l} represents candidate block 103 RF data values at a search location (k,l) (step 225). The power coefficient p may be an integer value greater than zero and is held constant throughout the method. The overall sum of (2) will always be positive due to the even power 2p.

As SEPD_{current} is incremented in a loop (indicated by step 235) where the reference block 101 RF data values (i,j) are compared with the candidate block 103 RF data values (i+k,j+l). For completeness, (2) can be further expanded to:

$$SEPD ( k , l ) = {\sum }_{i = - \frac{{S}_{i} - 1}{2}}^{\frac{{S}_{i} - 1}{2}} {\sum }_{J = - \frac{{S}_{j} - 1}{2}}^{\frac{{S}_{j} - 1}{2}} {[ {RF}_{1} ( I + i , J + j ) - {RF}_{2} ( I + i + k , J + J + l ) ]}^{2 p} , \qquad ( 3 )$$

where RF₁ represents the first RF data frame RF1 data values and RF₂ represents the second RF data frame RF2 data values. k and l represent the search location of the second data frame RF2, Sᵢ and Sⱼ are respective predetermined row and column boundaries that define the reference 101 and candidate 103 block areas, and I and J are respective global axial and lateral indices for the reference block 101 center location where the displacement is being estimated from.

The invention reduces computation time by comparing the SEPD_{current} value with the SEPDₘᵢₙ value for each data point (i,j) in a loop that incorporates the RF data values over which the SEPD is computed (steps 225, 235). If the RF data values between a reference block 101 and a candidate block 103 had similar, if not identical values, meaning that a particular search location (k,l) was a good match, SEPD_{current} would be close to zero for all RF data value comparisons.

If the SEPD_{current} is larger than the predetermined minimum SEPDₘᵢₙ, the search is stopped (step 230) for that search position (k,l) ending any further computation of an SEPD_{current} for that (k,l) search location (step 240).

The search process is finished if the given (k,l) marks the last search position (steps 245, 250), or, if the given position is not the last one (step 245), (k,l) is incremented (as shown in step 210) and the SEPD accumulation process is repeated, searching again for a smaller SEPDₘᵢₙ.

Given that the result of [RF₁(I+i,J+j)−RF₂(I+i+k,J+j+l)]^{2p} in (3) is a positive quantity due to the even 2p power, the summation process may stop if the partial sum SEPD_{current} is larger than the smallest SEPD value SEPDₘᵢₙ (step 230). An SEPD_{current} value that is larger than the smallest SEPD value SEPDₘᵢₙ provides a metric that indicates that computing the remaining sum of even power differences will not result in a minimum value. Continuing with the search would waste computation time.

If the SEPD_{current} remains less than the SEPDₘᵢₙ after indexing through all RF data value comparisons, and the summation from (3) finishes without breaking the loop, then the search position corresponding to the current (k,l) is assumed to be the best known block match (for that reference block and search position (k,l)) and SEPDₘᵢₙ is reinitialized with the value of SEPD_{current}, and the output coefficients (kₘᵢₙ,lₘᵢₙ) become the values of the current (k,l). (kₘᵢₙ,lₘᵢₙ) hold the position of the best known block match for that reference block 101 and SEPDₘᵢₙ is the minimum SEPD value obtained so far.

The invention saves additional computing resources by stopping the summation earlier for power coefficients p larger than one. In more detail, the result of [RF₁(I+i,J+j)−RF₂(I+i+k,J+j+l)]^{2p} from (3) exhibits increasing magnitudes with increasing powers p. This causes the summation process to stop earlier for larger p values at searching positions (k,l) other than the best known block match (kₘᵢₙ,lₘᵢₙ)

The choice of the power coefficient p is a balance between the number of multiplications per each summation process (2) and the total number of summations. Power coefficients p such as 1 require only one multiplication per each summation process. However, the relatively low values obtained for each (i,j) require a considerable amount of summations (2) before SEPD_{current} could be larger than SEPDₘᵢₙ at searching positions (k,l) other than the best known block match (kₘᵢₙ,lₘᵢₙ).

Power coefficients p larger than 1 (p=2, 3, 4, . . . ,x) reduce the number of summations but increase the number of multiplications. The choice of power coefficient p is limited by the amplitude (bit length) of the RF data values.

The optimal power coefficient p may be chosen depending on the system architecture used to perform the method of the invention. Software, hardware, or a combination of software and hardware architectures may be used to implement the invention. Many processors such as DSPs (digital signal processors), FPGAs (field programmable gate arrays), and ASICs (application specific integrated circuits) contain designated circuitry for multipliers and adders. To validate the embodiment, the invention used a power coefficient p of 4.

To further reduce computation time, the invention optimally indexes the search position (k,l). The method shown in FIG. 2 may be optimized by reducing the amount of search areas over which the first data frame RF1 is compared with the second data frame RF2 by delivering displacements, or search positions in an order where the search starts with a position most likely to deliver the best known block match (kₘᵢₙ,lₘᵢₙ).

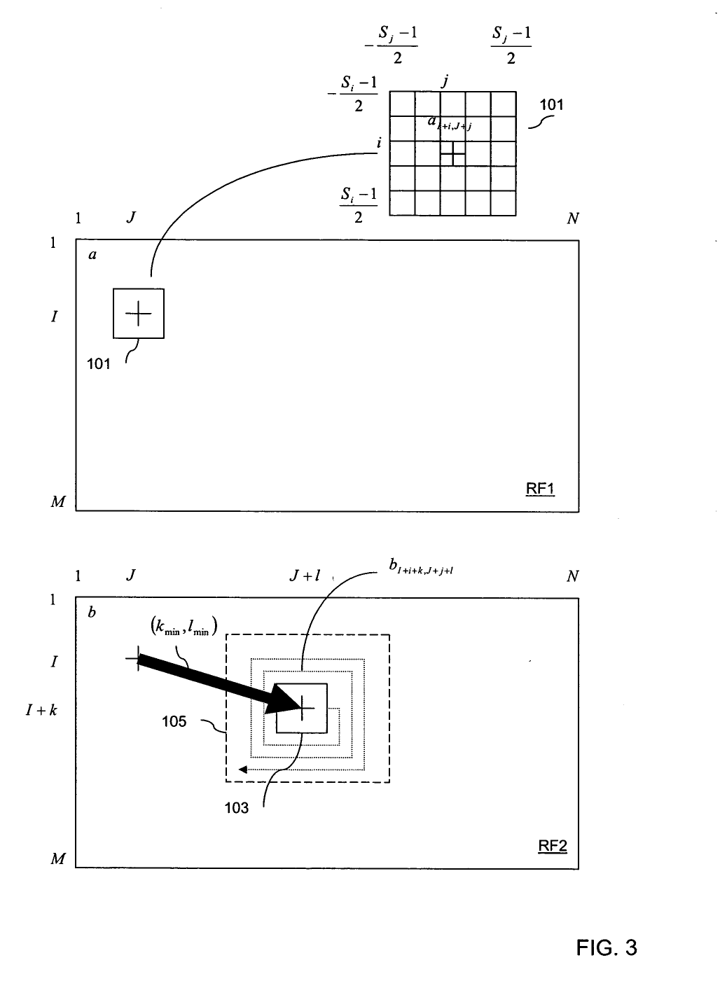

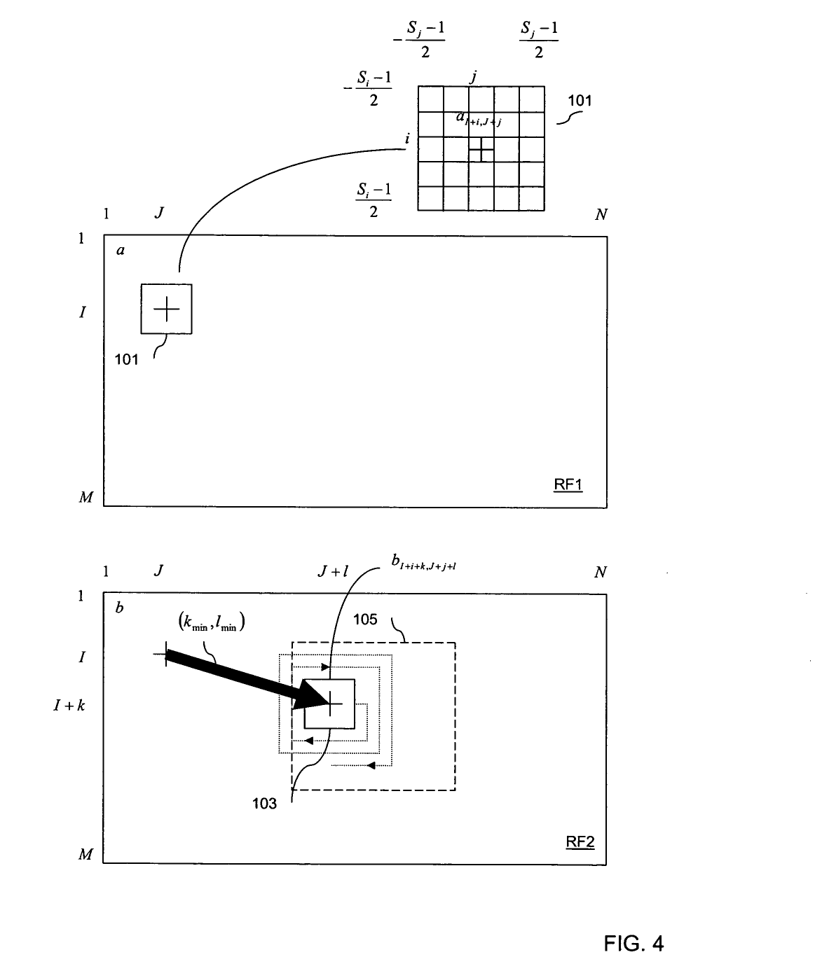

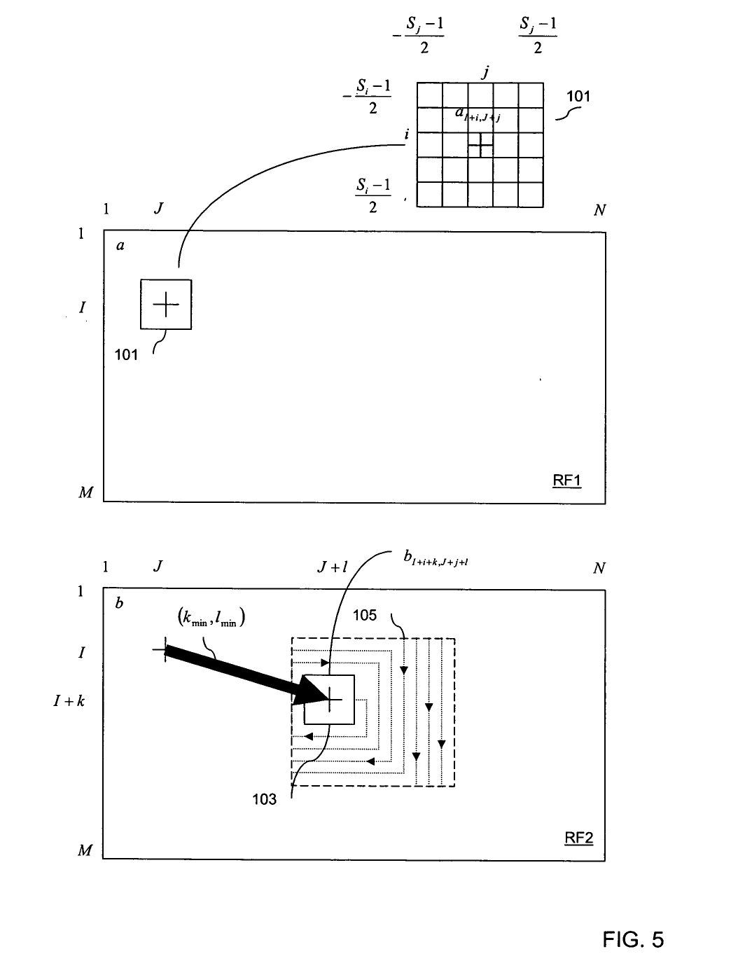

Shown in FIG. 3 is an embodiment of an optimized block matching search. As opposed to the search pattern shown in FIGS. 1A and 1B, the initial displacement (k,l) corresponds to a best prediction (kₘᵢₙ,lₘᵢₙ). Each subsequent displacement (k,l) is derived such that the search is performed on a spiral centered on the best predicted search position. The overall search area is shown by a dashed rectangle.

By providing each subsequent displacement (k,l) on a spiral pattern centered on the best prediction, the final value of SEPDₘᵢₙ for the given I and J (3) may be obtained during the first iterations corresponding to the first values (k,l). The summation of (3) may stop for any remaining (k,l) values once the partial sum SEPD_{current} exceeds the SEPDₘᵢₙ value, thereby saving computation time.

Alternatively, if the (k,l) coefficients are delivered in a conventional way such as (0,0),(0,1),(0,2), . . . ,(0,lₘₐₓ), . . . ,(kₘₐₓ,0),(kₘₐₓ,1),(kₘₐₓ,2), . . . ,(kₘₐₓ,lₘₐₓ), where kₘₐₓ, lₘₐₓ represent the maximum values k and l, respectively, the summation process is not stopped after only few first coefficients but only after reaching the minimum SEPDₘᵢₙ value for the given I and J, which may occur anywhere in the search. As previously discussed, adding all the remaining elements from the summation of (2) after the partial sum SEPD_{current} already exceeds the known SEPDₘᵢₙ, does not assist the search, but wastes computation time and resources, so the sooner the final value of SEPDₘᵢₙ is obtained, the sooner the summation process can be stopped saving computation time.

To predict a best known block match (kₘᵢₙ,lₘᵢₙ), an average of the positions of the best known block matches from the adjacent, top, right, left and/or bottom (kₘᵢₙ,lₘᵢₙ) positions, can be performed corresponding to previous I and J values already used (2). The prediction of (kₘᵢₙ,lₘᵢₙ) may be performed after obtaining a sufficient set of neighboring (kₘᵢₙ,lₘᵢₙ) values, that is at least one row of searches completed. For the initial I and J values, in the absence of already determined (kₘᵢₙ,lₘᵢₙ) values, no prediction may be carried out, and the indexing of k and l should be carried out conventionally, as shown in FIG. 1B 105. Alternative methods other than conventional averaging may be employed to predict the best known block match (kₘᵢₙ,lₘᵢₙ) such as weighted averaging performed over a selected number of previously searched positions I and J and others.

The method shown in FIG. 3 illustrates where a search area is centered on the best prediction (kₘᵢₙ,lₘᵢₙ). To quickly show a tissue compression motion, the search area may be modified to encompass specific regions from the compression image data.

The search area may be adjusted on an upper area of the predicted best known search position for a compression motion, or on a lower area of the predicted best known search position for a decompression motion. Additionally, the search area can be significantly reduced laterally, if the tissue motion occurs primarily on the vertical.

FIG. 4 shows an offset search area depicted by a dashed rectangle 105. The start of the search is centered on the best known search location. To optimize the block matching algorithm, the coefficients (k,l) provided are still describing a spiral centered on the predicted best known search position 403 as shown by the dotted arrow. The search, however, is limited to the reduced area as shown in FIG. 5.

The invention further reduces computation time by partially presorting the reference block 101 RF data values a_{i,j}. The data a_{i,j} are sorted by decreasing absolute values and are used in the summation process. The reference block 101 values a are no longer indexed as (i,j), but as partially sorted indices (iₚᵣₑₛₒᵣₜ(m), jₚᵣₑₛₒᵣₜ(m)), indexed by m=1: (Sᵢ×Sⱼ).

The partial summation from (2) becomes

$${SEPD}_{current} += {( {a}_{( {i}_{presort} ( m ) , {j}_{presort} ( m ) )} - {b}_{( {i}_{presort} ( m ) + k , {j}_{presort} ( m ) + l )} )}^{2 p} . \qquad ( 4 )$$

By accumulating SEPD_{current} values starting with the reference block 101 RF data a having the largest (absolute) values the results of SEPD_{current} may be large values from the first few iterations. Since reference block 101 RF data a are being compared to the same matrix of RF data found in a candidate block, the indices (iₚᵣₑₛₒᵣₜ(m),jₚᵣₑₛₒᵣₜ(m)) used for the reference block 101 RF data a will be the same indices (iₚᵣₑₛₒᵣₜ(m)+k,jₚᵣₑₛₒᵣₜ(m)+l) used for candidate block 103 RF data b plus a displacement (k,l). The decision if SEPD_{current}>SEPDₘᵢₙ (step 230) breaks the summation loop faster for a given search position (k,l).

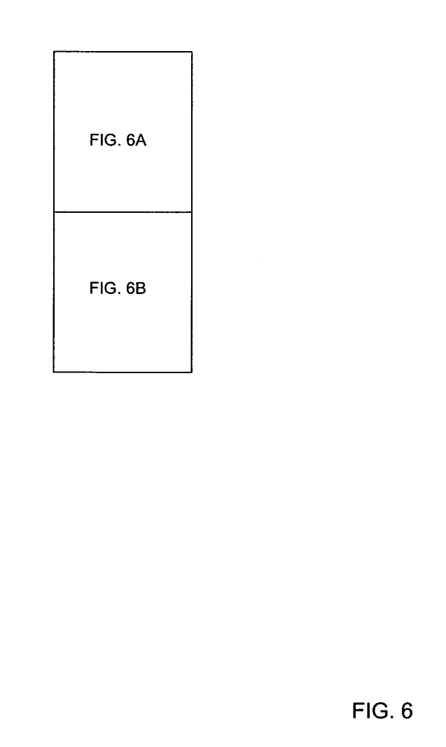

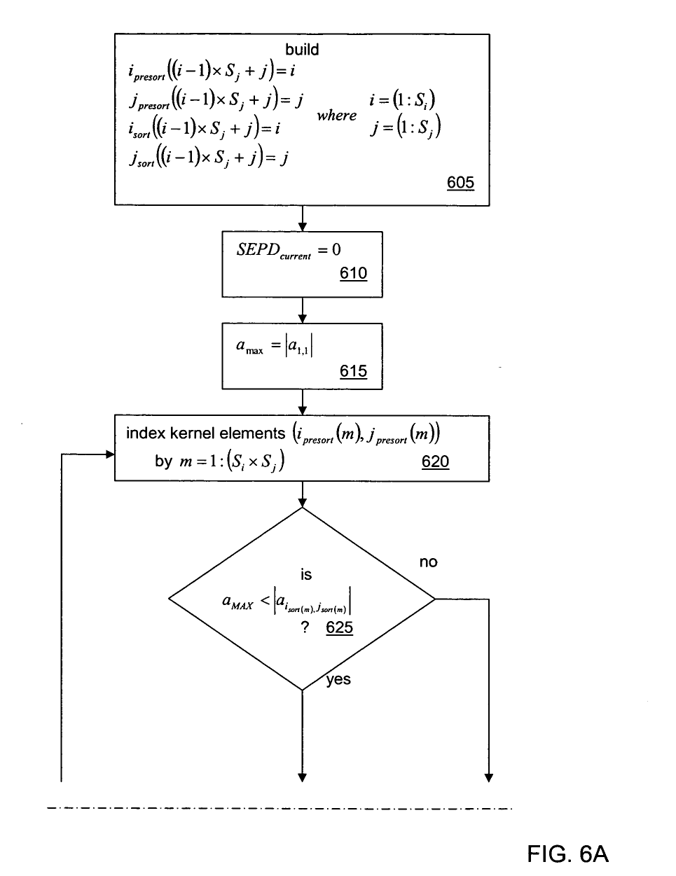

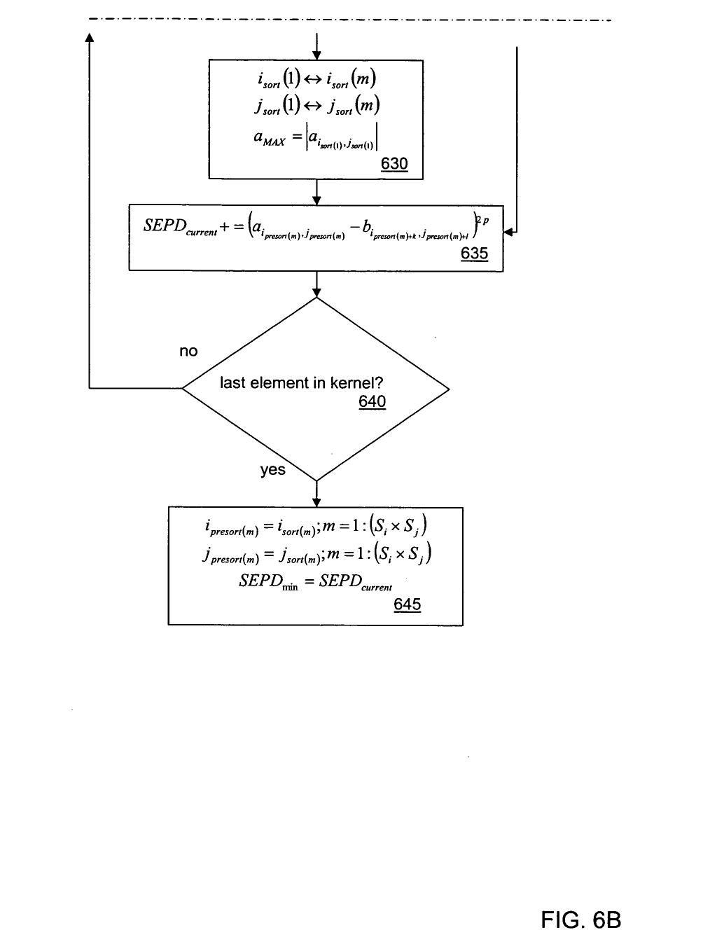

To further minimize execution time, the method does not initialize SEPDₘᵢₙ to a MAX value as in the method shown in FIG. 2. The initial SEPDₘᵢₙ is obtained for the (k,l) position most likely to deliver the best known block match using a prediction as described above. Execution time is further reduced by excluding the decision SEPD_{current}>SEPDₘᵢₙ during the initialization process since there is no SEPDₘᵢₙ to compare. The initialization method is shown in FIG. 6.

During initialization, a first partial sorting of the reference block 101 RF data value a_{I+i,J+j} indices i,j is performed (iₛₒᵣₜ(m),jₛₒᵣₜ(m)) where m=1:(Sᵢ×Sⱼ). The sorting is carried out for the first index position (iₛₒᵣₜ(1),jₛₒᵣₜ(1)) corresponding to the reference block 101 RF data value having the largest absolute value which is mapped to the first index. The sort only finds the reference block 101 RF data value having the largest absolute value.

Initialization begins by assembling a vector data store for the sorting procedure

$$\begin{matrix}\begin{matrix}\begin{matrix}{i}_{presort} ( ( i - 1 ) \times {S}_{j} + j ) = i \\ {j}_{presort} ( ( i - 1 ) \times {S}_{j} + j ) = j\end{matrix} \\ {i}_{sort} ( ( i - 1 ) \times {S}_{j} + j ) = i\end{matrix} \\ {j}_{sort} ( ( i - 1 ) \times {S}_{j} + j ) = j\end{matrix} where \begin{matrix}i = ( 1 \text{:} {S}_{i} ) \\ j = ( 1 \text{:} {S}_{j} )\end{matrix} , \qquad ( 5 )$$

step (605) and initializing an SEPD_{current} value to 0 (step 610).

An RF data value variable a_{MAX} is initialized with the absolute value of the first RF data value from the reference block 101 a_{I+1,J+1} (step 615). For every index value m, where m=1:(Sᵢ×Sⱼ) is the total number of RF data values in a reference block, SEPD_{current} accumulates the partial sum as in (4), while iₛₒᵣₜ(1) and jₛₒᵣₜ(1) are written to hold the index coefficients (i,j) of the reference block 101 RF data value a_{I+i,J+j} having the largest absolute value (step 625). This is performed by comparing the absolute value of every RF data value of the reference block 101 a_{I+i,J+j} with a_{MAX}, and replacing a previous a_{MAX} value with a new value if larger (steps 625, 630).

Once all of the reference block 101 RF data values a_{I+i,J+j} have been accounted for, the partially sorted indices iₛₒᵣₜ(m) and jₛₒᵣₜ(m) are copied into the (iₚᵣₑₛₒᵣₜ(m), jₚᵣₑₛₒᵣₜ(m)) indices. The (iₚᵣₑₛₒᵣₜ(m),jₚᵣₑₛₒᵣₜ(m)) indices are used for SEPD summation. The indices (iₚᵣₑₛₒᵣₜ(m),jₚᵣₑₛₒᵣₜ(m)) used for the reference block 101 RF data values a_{I+i,J+j} will be the same indices (iₚᵣₑₛₒᵣₜ(m)+k,jₚᵣₑₛₒᵣₜ(m)+l) used for a candidate block 103 RF data values b_{I+i+k,J+j+l} including a displacement (k,l) (step 635). Additionally, SEPDₘᵢₙ is initialized with the final value of SEPD_{current} (steps 640, 645).

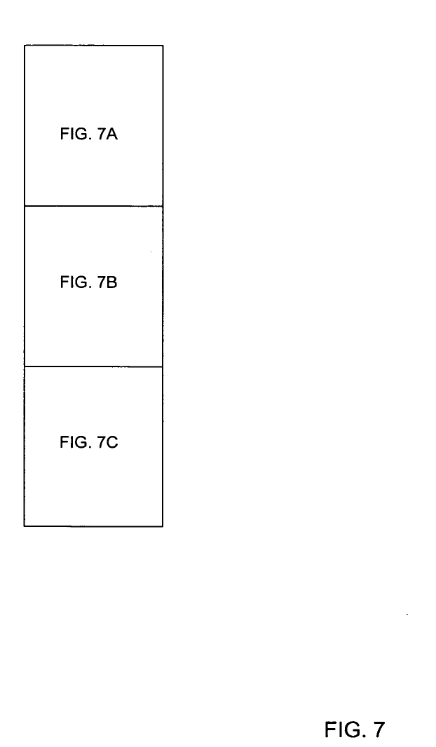

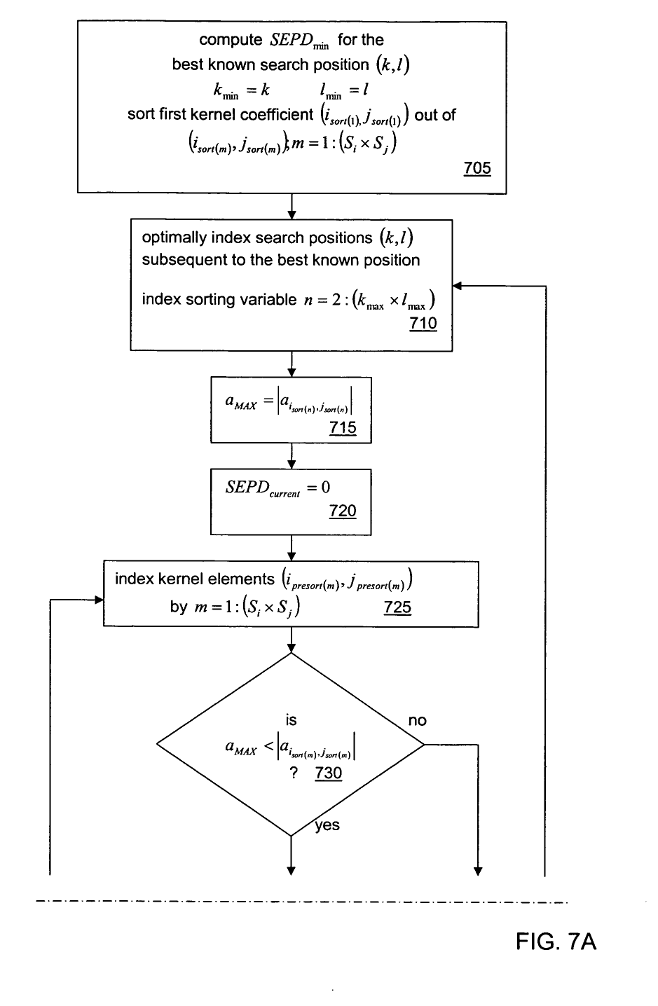

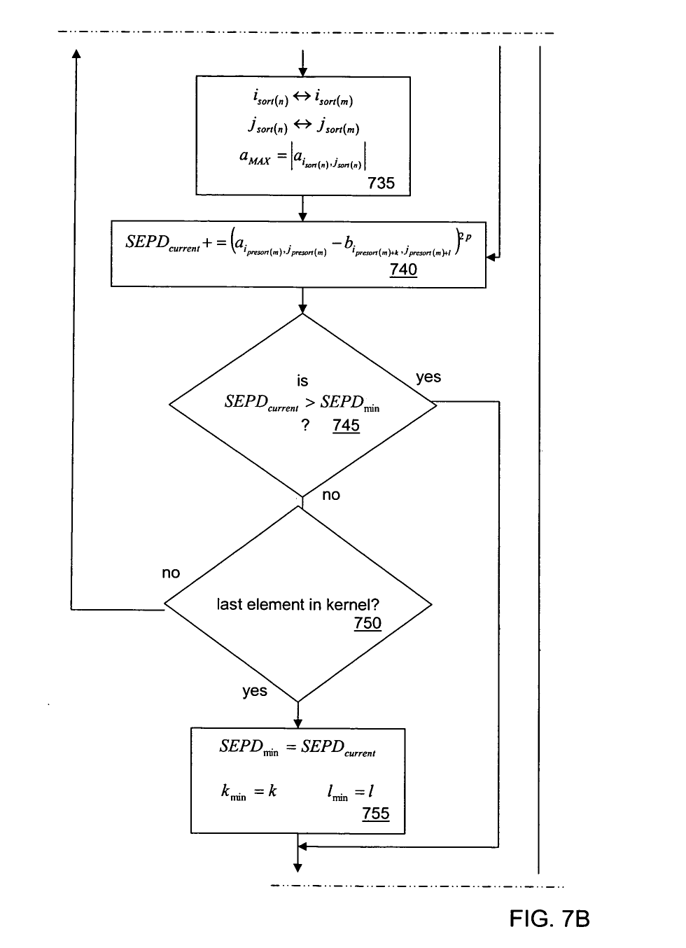

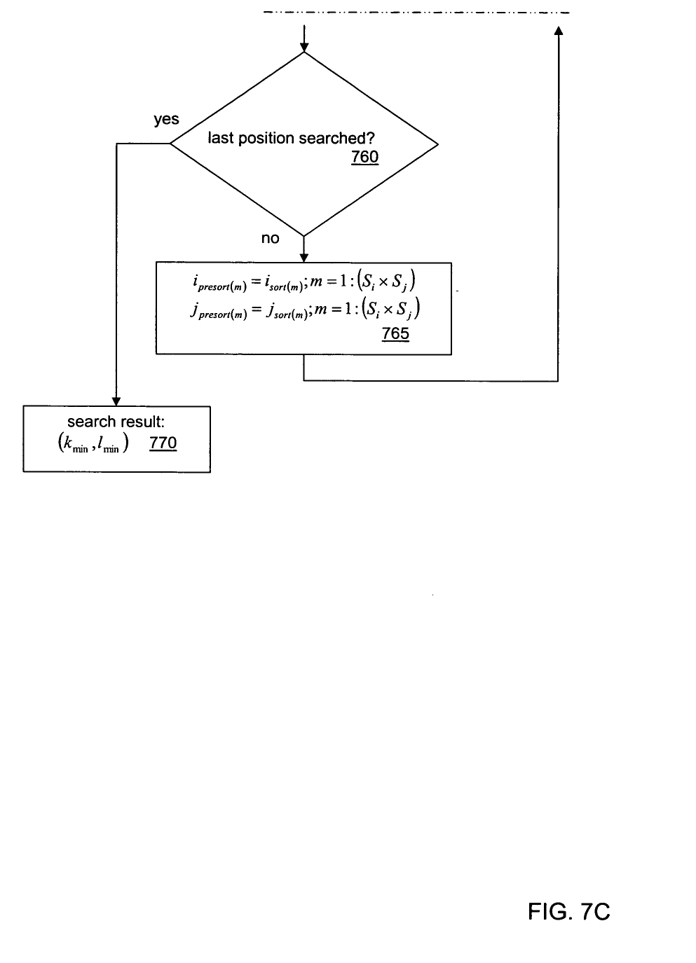

After SEPDₘᵢₙ initialization is complete, a block matching search is performed as shown in FIG. 7. The output variables (kₘᵢₙ,lₘᵢₙ) are initialized with a displacement that will most likely deliver the best known block match (the same position used during initialization). The partially sorted reference block RF data value index coefficients (iₛₒᵣₜ(m), jₛₒᵣₜ(m)) and (iₚᵣₑₛₒᵣₜ(m), jₚᵣₑₛₒᵣₜ(m)) are used in the block matching method (step 705). The search positions (k,l) are provided per a best known presumption as described above.

The method begins with the reference block 101 RF data value a_{I+i,J+j} position i,j next to the one used during initialization. The total number of search positions is (kₘₐₓ×lₘₐₓ−1) (step 710) where kₘₐₓ and lₘₐₓ are search boundaries. When the search positions (k,l) are updated, a counter n is indexed with values from 2 to kₘₐₓ×lₘₐₓ. The counter n is used within the method to continue the partial sorting started during the initialization process shown in FIG. 6.

As performed during initialization, the value of a_{MAX} is the absolute value of the n^{th} partially sorted reference block RF data value a_{I+i,J+j} (step 715). SEPD_{current} is set to 0 (step 720).

The SEPD score from (3) is built incrementally, as in (4), for m=1:(Sᵢ×Sⱼ) (step 725). The partially sorted reference block index coefficients used to index the elements from the reference block 101 to b are (iₚᵣₑₛₒᵣₜ(m),jₚᵣₑₛₒᵣₜ(m)). As the sorting procedure occurs in parallel with incrementing the SEPD, the index coefficients (iₛₒᵣₜ(m),jₛₒᵣₜ(m)) cannot be used. Instead, index coefficients (iₚᵣₑₛₒᵣₜ(m),iₚᵣₑₛₒᵣₜ(m)) hold the partially sorted coefficients (iₛₒᵣₜ(m),jₛₒᵣₜ(m)) as per the previous search step (n−1) (step 765). The partial sorting is performed similarly with the initialization procedure, that is iₛₒᵣₜ(n) and jₛₒᵣₜ(n) are modified as needed to hold the index coefficients (i,j) of the element of a having the nₜₕ largest absolute value. This is performed by comparing the absolute values of the (iₛₒᵣₜ(m),jₛₒᵣₜ(m)) elements of a with a_{MAX}, and updating a_{MAX} to hold the largest absolute value encountered (step 735).

The method compares the SEPD_{current} with SEPDₘᵢₙ for each reference block 101 RF data point (iₚᵣₑₛₒᵣₜ(m),jₚᵣₑₛₒᵣₜ(m)) in a loop that incorporates the area over which the SEPD is computed (step 745). If SEPD_{current} is larger than the already known minimum SEPDₘᵢₙ, the loop is broken for the given search position (k,l) and the computation of the sum shown in (3) is not finished (step 745). Then the entire search process is finished if the given (k,l) marks the last search position (steps 760, 770). If the given position is not the last one, the partially sorted indices iₛₒᵣₜ(m) and jₛₒᵣₜ(m) are copied into (iₚᵣₑₛₒᵣₜ(m),jₚᵣₑₛₒᵣₜ(m)), and (k,l) takes on new values, and n is incremented (step 765 and back to 710).

The SEPD accumulation and the partial sort processes are repeated, searching again for a smaller SEPDₘᵢₙ (step 745) and a larger a_{MAX} (step 715), respectively. Same as the method shown in FIG. 2, if the SEPD_{current} is less than the SEPDₘᵢₙ after indexing all of the reference block RF data values (iₚᵣₑₛₒᵣₜ(m),jₚᵣₑₛₒᵣₜ(m)), that is the summation from (3) finishes without breaking the loop, then the position corresponding to the current (k,l) is the best known block match so far and the SEPDₘᵢₙ is reinitialized with the value of SEPD_{current} and the output coefficients (kₘᵢₙ,lₘᵢₙ) take the values of the current (k,l) (step 755).

(kₘᵢₙ,lₘᵢₙ) always hold the position of the best known block match (displacement) and SEPDₘᵢₙ is the smallest SEPD obtained during the execution of the algorithm. Once all of the reference block RF data values a_{I+i,J+j} are accounted for, the partially sorted indices iₛₒᵣₜ(m) and jₛₒᵣₜ(m) are copied into (iₚᵣₑₛₒᵣₜ(m),jₚᵣₑₛₒᵣₜ(m)) (step 765).

It should be noted that the (iₚᵣₑₛₒᵣₜ(m),jₚᵣₑₛₒᵣₜ(m)) indices have practically no chance of being fully sorted during the normal operation of the algorithm, as the sorting operation is stopped together with the summation when SEPD_{current}>SEPDₘᵢₙ, and kₘₐₓ×lₘₐₓ is usually smaller than Sᵢ×Sⱼ. However, (iₚᵣₑₛₒᵣₜ(1),jₚᵣₑₛₒᵣₜ(1)) corresponds to the RF data value of a having the largest absolute value and a set of subsequent presorted indices correspond with RF data values of a with decreasing absolute values. This aspect of the invention accelerates the block matching execution, especially for RF data collected from tissue that contains multiple local maxima and minima that correspond to various tissue structures, local maxima and minima that are not global for the entire data set.

As these maxima and minima are accounted first in the SEPD summation process due to indices' partial sorting, SEPD_{current} gains larger values from the first few iterations, and the decision SEPD_{current}>SEPDₘᵢₙ from FIG. 2 breaks the summation loop faster (after fewer additions) for a given search position (k,l), as described.

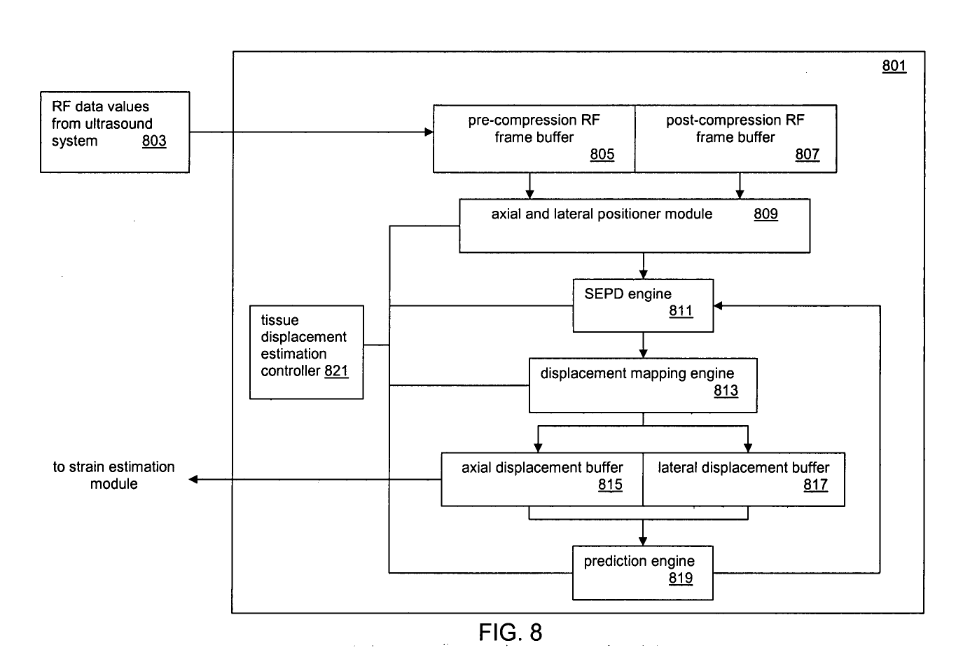

Shown in FIG. 8 is a corresponding framework 801 of the various modules that comprise the invention. The invention is a modular framework and may be deployed as software, as hardware, or as a combination of software and hardware.

The invention framework 801 receives RF frame data 803 from an ultrasound system. The coupled modules include buffers for pre-compression 805 and post-compression 807 RF frame data, an axial and lateral positioner module 809, an SEPD engine 811, a displacement mapping engine 813, buffers for the axial 815 and lateral 817 displacements, and a prediction engine 819. A controller 821 provides for synchronization and communication between the activities of the axial and lateral positioner module 809, SEPD engine 811, displacement mapping engine 813 and predication engine 819.

RF data values corresponding to two RF frames are output from an ultrasound system and are input to the framework 801 for processing. The two RF data frames are stored in corresponding pre-compression 805 and post-compression 807 RF frame buffers. The pre-compression data is collected prior to tissue compression and the second RF data frame is collected after tissue compression.

The axial and lateral positioner 809 reads the RF data from the two input buffers 805, 807, allocates memory and assigns addresses of where to store and read the RF data values during processing. After memory allocation, the positioner 809 forwards the RF data values to the SEPD engine 811 for a displacement computation.

In accordance with the method, the SEPD module 811 performs the displacement computation for each individual location provided by the positioner 809. The individual axial and lateral displacement results are further processed by the displacement mapping engine 813. The data is forwarded to the dual buffer output 815, 817.

The prediction engine 819 provides the SEPD engine 811 with a motion estimate in both axial and lateral directions based on previously computed displacements. The prediction engine 819 accelerates the SEPD computation time as described earlier. The axial 815 and lateral 817 displacements are output and collated to compute a strain estimation between the pre-compression and post-compression RF data frames.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for determining a best displacement between first and second data frames containing RF data values comprising:
indexing the RF data values for the first and second frames;
choosing an RF data value from the first frame as a center point;
creating a reference block comprising a plurality of first frame RF data values surrounding said center point;
choosing a displacement from a finite number of displacements between said center point and an RF data value that maps to an RF data value in the second frame;
performing a sum of even power differences (SEPD) between said reference block RF data values and RF data values in the second frame displaced by said displacement that map to said reference block RF data values and form a candidate block comprising:
a) setting a minimum SEPD;
b) calculating a current SEPD from a difference between a reference block RF data value and a corresponding candidate block RF data value with said difference raised to an even power; and
c) comparing said current SEPD with said minimum SEPD.

2. The method according to claim 1 wherein said even power is greater than or equal to 2.

3. The method according to claim 1 wherein said even power depends on software and hardware used to implement said SEPD.

4. The method according to claim 2 further comprising:
repeating steps b) and c) for another reference block RF data value if said current SEPD is less than or equal to said minimum SEPD; and
summing each subsequent current SEPD with a previous current SEPD.

5. The method according to claim 4 further comprising:
replacing said minimum SEPD with said current SEPD value and storing the displacement if all of said reference block RF data values have been processed; and
choosing a subsequent displacement.

6. The method according to claim 5 wherein if said current SEPD is greater than said minimum SEPD, choosing another displacement from said finite number of displacements if available.

7. The method according to claim 6 wherein if said current SEPD is greater than said minimum SEPD and all displacements from said finite number of displacements have been accounted for, a last used displacement that accounted for all RF data points of a candidate block delivering the lowest current SEPD value is the best displacement.

8. The method according to claim 5 wherein if said current SEPD is less than or equal to said minimum SEPD and all RF data values from said reference block have been processed, setting said minimum SEPD to said current SEPD value and storing the displacement.

9. The method according to claim 8 wherein if said current SEPD value is less than or equal to said minimum SEPD value and all RF data values from said reference block have been processed and all displacements from said finite number of displacements have been accounted for, a last used displacement that accounted for all RF data points of a candidate block delivering the lowest current SEPD value is the best displacement.

10. The method according to claim 5 wherein a first displacement is a prediction of the best displacement.

11. The method according to claim 10 further comprising choosing each subsequent displacement as a spiral pattern around said first displacement.

12. The method according to claim 10 further comprising choosing each subsequent displacement in a predetermined search pattern.

13. The method according to claim 10 further comprising choosing each subsequent displacement in a predetermined direction in the second frame according to a second frame characteristic.

14. The method according to claim 11 further comprising:
defining a search quadrangle in said second frame centered on an RF data value determined by said center point and said first displacement; and
for subsequent displacements, excluding portions of said spiral pattern outside of said search quadrangle.

15. The method according to claim 14 further comprising sizing said search quadrangle according to a predetermined search area.

16. The method according to claim 11 further comprising:
defining a search quadrangle in the second frame not centered on said center point and said first displacement; and
for subsequent displacements, excluding portions of said spiral pattern outside of said search quadrangle.

17. The method according to claim 16 further comprising sizing and orienting said search quadrangle according to a predetermined search area.

18. A method for determining a best displacement between first and second data frames containing RF data values comprising:
indexing the RF data value positions for the first and second frames;
choosing an RF data value from the first frame as a center point;
creating a reference block comprising a plurality of first frame RF data values surrounding said center point;
choosing a displacement from a finite number of displacements between said center point and an RF data value that maps to an RF data value in the second frame; and
performing a sum of even power differences (SEPD) between said reference block RF data values and RF data values in the second frame displaced by said displacement that map to said reference block RF data values and form a candidate block comprising:
a) calculating a current SEPD from a difference between a reference block RF data value and a corresponding candidate block RF data value with said difference raised to an even power; and
b) comparing an absolute value of a reference block RF data value with an absolute value of a next RF data value from said reference block to find the largest reference block RF absolute data value and mapping said largest absolute value to a first position in a partially sorted index.

19. The method according to claim 18 wherein said even power is greater than or equal to 2.

20. The method according to claim 18 wherein said even power depends on software and hardware used to implement said SEPD.

21. The method according to claim 19 further comprising:
repeating step a) for another reference block RF data value;
summing each subsequent current SEPD with a previous current SEPD; and
repeating step b) to compare a next reference block RF absolute data value with said absolute value mapped to said first position in said partially sorted index and mapping said largest absolute value to said first position in said partially sorted index.

22. The method according to claim 21 further comprising setting a minimum SEPD to said current SEPD value and replacing presorted indices with said partially sorted indices storing said reference block RF data value comparisons.

23. The method according to claim 22 further comprising:
choosing a subsequent displacement; and
performing a sum of even power differences (SEPD) between said reference block RF data values and RF data values in the second frame displaced by a subsequent displacement that map to said reference block RF data values and form a candidate block comprising:
a) calculating a current SEPD from a difference between said largest reference block RF data value and a corresponding candidate block RF data value with said difference raised to an even power; and
b) comparing an absolute value of each said reference block RF data value with an absolute value of a next RF data value from said reference block to find a next largest reference block RF absolute data value and mapping said next largest absolute value to a subsequent position in said partially sorted index.

24. The method according to claim 23 further comprising:
repeating step a) for another reference block RF data value if said current SEPD is less than or equal to said minimum SEPD; and
summing each subsequent current SEPD with a previous current SEPD; and
repeating step b) to compare a next reference block RF absolute data value with said absolute value mapped to said subsequent position in said partially sorted index and mapping said largest absolute value to said subsequent position in said partially sorted index.

25. The method according to claim 24 further comprising:
replacing said minimum SEPD with said current SEPD value and storing the displacement if all of said reference block RF data values have been processed;
choosing a subsequent displacement; and
using said presorted indices sorted during a current step for a next displacement.

26. The method according to claim 25 wherein if said current SEPD is greater than said minimum SEPD, choosing another displacement from said finite number of displacements if available and using said presorted indices sorted during a current step for a next displacement.

27. The method according to claim 26 wherein if said current SEPD is greater than said minimum SEPD and all displacements from said finite number of displacements have been accounted for, a last used displacement that accounted for all RF data points of a candidate block delivering the lowest current SEPD value is the best displacement.

28. The method according to claim 25 wherein if said current SEPD is less than or equal to said minimum SEPD and all RF data values from said reference block have been processed, setting said minimum SEPD to said current SEPD value and storing the displacement and using said presorted indices sorted during a current step for a next displacement.

29. The method according to claim 28 wherein if said current SEPD value is less than or equal to said minimum SEPD value and all RF data values from said reference block have been processed and all displacements from said finite number of displacements have been accounted for, a last used displacement that accounted for all RF data points of a candidate block delivering the lowest current SEPD value is the best displacement.

30. The method according to claim 25 wherein a first displacement is a prediction of the best displacement.

31. The method according to claim 30 further comprising choosing each subsequent displacement as a spiral pattern around said first displacement.

32. The method according to claim 30 further comprising choosing each subsequent displacement in a predetermined search pattern.

33. The method according to claim 30 further comprising choosing each subsequent displacement in a predetermined direction in the second frame according to a second frame characteristic.

34. The method according to claim 31 further comprising:
defining a search quadrangle in said second frame centered on an RF data value determined by said center point and said first displacement; and
for subsequent displacements, excluding portions of said spiral pattern outside of said search quadrangle.

35. The method according to claim 34 further comprising sizing said search quadrangle according to a predetermined search area.

36. The method according to claim 31 further comprising:
defining a search quadrangle in the second frame not centered on said center point and said first displacement; and
for subsequent displacements, excluding portions of said spiral pattern outside of said search quadrangle.

37. The method according to claim 36 further comprising sizing and orienting said search quadrangle according to a predetermined search area.

38. A system for determining a best displacement between first and second data frames containing RF data values comprising:
means for indexing the RF data values for the first and second frames;
means for choosing an RF data value from the first frame as a center point;
means for creating a reference block comprising a plurality of first frame RF data values surrounding said center point;
means for choosing a displacement from a finite number of displacements between said center point and an RF data value that maps to an RF data value in the second frame;
means for performing a sum of even power differences (SEPD) between said reference block RF data values and RF data values in the second frame displaced by said displacement that map to said reference block RF data values and form a candidate block comprising:
a) means for setting a minimum SEPD;
b) means for calculating a current SEPD from a difference between a reference block RF data value and a corresponding candidate block RF data value with said difference raised to an even power; and
c) means for comparing said current SEPD with said minimum SEPD.

39. The system according to claim 38 wherein said even power is greater than or equal to 2.

40. The system according to claim 38 wherein said even power depends on software and hardware used to implement said SEPD.

41. The system according to claim 39 further comprising:
means for repeating steps b) and c) for another reference block RF data value if said current SEPD is less than or equal to said minimum SEPD; and
means for summing each subsequent current SEPD with a previous current SEPD.

42. The system according to claim 41 further comprising:
means for replacing said minimum SEPD with said current SEPD value and means for storing the displacement if all of said reference block RF data values have been processed; and
means for choosing a subsequent displacement.

43. The system according to claim 42 wherein if said current SEPD is greater than said minimum SEPD, choosing another displacement from said finite number of displacements if available.

44. The system according to claim 43 wherein if said current SEPD is greater than said minimum SEPD and all displacements from said finite number of displacements have been accounted for, a last used displacement that accounted for all RF data points of a candidate block delivering the lowest current SEPD value is the best displacement.

45. The system according to claim 42 wherein if said current SEPD is less than or equal to said minimum SEPD and all RF data values from said reference block have been processed, setting said minimum SEPD to said current SEPD value and storing the displacement.

46. The system according to claim 45 wherein if said current SEPD value is less than or equal to said minimum SEPD value and all RF data values from said reference block have been processed and all displacements from said finite number of displacements have been accounted for, a last used displacement that accounted for all RF data points of a candidate block delivering the lowest current SEPD value is the best displacement.

47. The system according to claim 42 wherein a first displacement is a prediction of the best displacement.

48. The system according to claim 47 further comprising means for choosing each subsequent displacement as a spiral pattern around said first displacement.

49. The system according to claim 47 further comprising means for choosing each subsequent displacement in a predetermined search pattern.

50. The system according to claim 47 further comprising means for choosing each subsequent displacement in a predetermined direction in the second frame according to a second frame characteristic.

51. The system according to claim 48 further comprising:
means for defining a search quadrangle in said second frame centered on an RF data value determined by said center point and said first displacement; and
for subsequent displacements, means for excluding portions of said spiral pattern outside of said search quadrangle.

52. The system according to claim 51 further comprising means for sizing said search quadrangle according to a predetermined search area.

53. The system according to claim 48 further comprising:
means for defining a search quadrangle in the second frame not centered on said center point and said first displacement; and
for subsequent displacements, means for excluding portions of said spiral pattern outside of said search quadrangle.

54. The system according to claim 53 further comprising means for sizing and orienting said search quadrangle according to a predetermined search area.

55. A system for determining a best displacement between first and second data frames containing RF data values comprising:
means for indexing the RF data value positions for the first and second frames;
means for choosing an RF data value from the first frame as a center point;
means for creating a reference block comprising a plurality of first frame RF data values surrounding said center point;
means for choosing a displacement from a finite number of displacements between said center point and an RF data value that maps to an RF data value in the second frame; and
means for performing a sum of even power differences (SEPD) between said reference block RF data values and RF data values in the second frame displaced by said displacement that map to said reference block RF data values and form a candidate block comprising:
a) means for calculating a current SEPD from a difference between a reference block RF data value and a corresponding candidate block RF data value with said difference raised to an even power; and
b) means for comparing an absolute value of a reference block RF data value with an absolute value of a next RF data value from said reference block to find the largest reference block RF absolute data value and mapping said largest absolute value to a first position in a partially sorted index.

56. The system according to claim 55 wherein said even power is greater than or equal to 2.

57. The system according to claim 55 wherein said even power depends on software and hardware used to implement said SEPD.

58. The system according to claim 56 further comprising:
means for repeating step a) for another reference block RF data value;
means for summing each subsequent current SEPD with a previous current SEPD; and
means for repeating step b) to compare a next reference block RF absolute data value with said absolute value mapped to said first position in said partially sorted index and mapping said largest absolute value to said first position in said partially sorted index.

59. The system according to claim 58 further comprising means for setting a minimum SEPD to said current SEPD value and means for replacing presorted indices with said partially sorted indices storing said reference block RF data value comparisons.

60. The system according to claim 59 further comprising:
means for choosing a subsequent displacement; and
means for performing a sum of even power differences (SEPD) between said reference block RF data values and RF data values in the second frame displaced by a subsequent displacement that map to said reference block RF data values and form a candidate block comprising:
a) means for calculating a current SEPD from a difference between said largest reference block RF data value and a corresponding candidate block RF data value with said difference raised to an even power; and
b) means for comparing an absolute value of each said reference block RF data value with an absolute value of a next RF data value from said reference block to find a next largest reference block RF absolute data value and mapping said next largest absolute value to a subsequent position in said partially sorted index.

61. The system according to claim 60 further comprising:
means for repeating step a) for another reference block RF data value if said current SEPD is less than or equal to said minimum SEPD;
means for summing each subsequent current SEPD with a previous current SEPD; and
means for repeating step b) to compare a next reference block RF absolute data value with said absolute value mapped to said subsequent position in said partially sorted index and mapping the largest absolute value to said subsequent position in said partially sorted index.

62. The system according to claim 61 further comprising:
means for replacing said minimum SEPD with said current SEPD value and means for storing the displacement if all of said reference block RF data values have been processed;
means for choosing a subsequent displacement; and
means for using said presorted indices sorted during a current step for a next displacement.

63. The system according to claim 62 wherein if said current SEPD is greater than said minimum SEPD, means for choosing another displacement from said finite number of displacements if available and means for using said presorted indices sorted during a current step for a next displacement.

64. The system according to claim 63 wherein if said current SEPD is greater than said minimum SEPD and all displacements from said finite number of displacements have been accounted for, a last used displacement that accounted for all RF data points of a candidate block delivering the lowest current SEPD value is the best displacement.

65. The system according to claim 62 wherein if said current SEPD is less than or equal to said minimum SEPD and all RF data values from said reference block have been processed, means for setting said minimum SEPD to said current SEPD value and means for storing the displacement and using said presorted indices sorted during a current step for a next displacement.

66. The system according to claim 65 wherein if said current SEPD value is less than or equal to said minimum SEPD value and all RF data values from said reference block have been processed and all displacements from said finite number of displacements have been accounted for, a last used displacement that accounted for all RF data points of a candidate block delivering the lowest current SEPD value is the best displacement.

67. The system according to claim 62 wherein a first displacement is a prediction of the best displacement.

68. The system according to claim 67 further comprising means for choosing each subsequent displacement as a spiral pattern around said first displacement.

69. The system according to claim 67 further comprising means for choosing each subsequent displacement in a predetermined search pattern.

70. The system according to claim 67 further comprising means for choosing each subsequent displacement in a predetermined direction in the second frame according to a second frame characteristic.

71. The system according to claim 68 further comprising:
means for defining a search quadrangle in said second frame centered on an RF data value determined by said center point and said first displacement; and
for subsequent displacements, means for excluding portions of said spiral pattern outside of said search quadrangle.

72. The system according to claim 71 further comprising means for sizing said search quadrangle according to a predetermined search area.

73. The system according to claim 68 further comprising:
means for defining a search quadrangle in the second frame not centered on said center point and said first displacement; and
for subsequent displacements, means for excluding portions of said spiral pattern outside of said search quadrangle.

74. The system according to claim 73 further comprising means for sizing and orienting said search quadrangle according to a predetermined search area.
